(19) United States
(12) Patent Application Publication
(10) Pub. No.: US 2008/0129046 A1
(43) Pub. Date: Jun. 5, 2008

(54) Attachment System For Fuel Pipe Assemblies and Method of Assembly Therefore

(75) Inventors: Eric G. Parker, Chicago, IL (US); Franco A. Cisternino, Deerfield, IL (US); Albert N. Diener, Melrose Park, IL (US)

Correspondence Address: LOWE, HAUPTMAN, GILMAN & BERNER, LLP (ITW), 1700 DIAGONAL ROAD, SUITE 300, ALEXANDRIA, VA, 22314, US

(73) Assignee: ILLINOIS TOOL WORKS INC., Glenview, IL (US)

(21) Appl. No.: 11/815,029

(22) PCT Filed: Feb. 13, 2006
(86) PCT No.: PCT/IB06/50468

§ 371 Date: Jul. 30, 2007

Related U.S. Application Data
(60) Provisional application No. 60/652,880, filed on Feb. 15, 2005.

(51) Int. Cl. F16L 37/00

(52) U.S. Cl. 285/305

(57) ABSTRACT

A connector is provided between a fuel pipe assembly and a fuel housing. The connector is in substantially fixed position relative to the fuel pipe assembly and has portions thereof which engage the fuel housing, thereby providing a physical connection between the fuel pipe assembly and housing whereby assembly is snap together, and unintended disconnect is inhibited.

### CROSS-REFERENCE TO RELATED APPLICATIONS

The present regular United States patent application claims the benefits of U.S. Provisional Application Ser. No. 60/652,880 filed on Feb. 15, 2005.

### FIELD OF THE INVENTION

The present invention relates to fuel systems for motor vehicles and, more specifically, the invention pertains to fuel pipe and housing assemblies and means of attaching such assemblies one to the other.

### BACKGROUND OF THE INVENTION

Fuel systems for motor vehicles are known to include a fuel tank and a filler tube through which fuel is dispensed into the tank. It is known to use a removable cap at the end of the filler tube to close the tube. A threaded fuel cap is the primary seal for the fuel system on most domestic vehicles. It also is known to use a movable damper and a rubber seal to close the fuel system either as the primary shutoff valve or as a secondary, supplemental shut-off structure. It also is known to use capless refueling systems wherein a screw-on cover is not required, and the act of inserting a filler nozzle opens the end of the tube for filling by moving a stopper that closes the tube.

The fuel pipe, primary and secondary shut-offs if supplied, capless refueling assemblies and/or screw-on caps (collectively referred to as ‘fuel pipe assemblies’) are connected at one end to the fuel tank and at an opposite end to a part of the vehicle body, which may include a housing having an access door or other structure at a location in the vehicle body where the filler system is accessed for providing fuel to the tank. The fuel pipe assemblies are known to be connected to the vehicle body or housing by a variety of means and procedures. Current known methods for connecting fuel pipe assemblies to vehicle structure are both cumbersome and time consuming. Different connection systems have been used for different types of fuel pipe assemblies, making installation and servicing more complicated with parts unique to specific assemblies. It is known also to provide a threaded connection between the fuel pipe assembly and housing, and to mount the fuel pipe assembly rigidly to the housing, which may include a rubber or foam component.

The variety of different means for connecting fuel pipe assemblies to housings complicates installation by increasing the number of different parts that must be stocked at assembly plants. Non-standardization of parts among different vehicle types increases the number of different parts that must be stocked and handled for servicing and repair. Tools are required in some such assemblies both for initial installation and for disassembly for servicing. Further, some rigid connections are difficult to connect during initial assembly, and even more difficult to disconnect sometime later if repairs are needed.

It is desirable to provide structure and procedures for connecting fuel pipe assemblies to fuel housings that fit in existing vehicle architecture and that will work with different types of fuel systems, either capped systems or uncapped systems. It is desirable to provide connecting structure that can be installed easily, without tools and with minimal force while also providing a strong, secure connection. Of course, the components and system must work well in a corrosive environment and when exposed to vehicle fuel. It is desirable for the system to be easily serviceable and tolerant of misalignment or variation during assembly.

### SUMMARY OF THE INVENTION

The present invention provides connections between fuel pipe assemblies and fuel system housings that are easy to install and service, while being secure.

In one aspect thereof, the present invention provides a vehicle refueling system with a housing having a collar defining an abutment and a fuel pipe assembly having an end defining a channel. The end is received in the collar. A connector disposed in the channel of the fuel pipe assembly engages the abutment in the collar.

In another aspect thereof, the present invention provides a connector assembly for a vehicle refueling system having a fuel pipe assembly and a fuel housing. The connector assembly has a connector held by one of the fuel pipe assembly and fuel housing in a substantially fixed position. A portion of the connector extends toward the other of the fuel pipe assembly and the fuel housing, which defines an abutment that engages the connector.

In a still further aspect thereof, the present invention provides a method for connecting a vehicle fuel pipe assembly to a fuel housing. The method has steps of providing at least one connector secured in position relative to one of the fuel pipe assembly and the fuel housing; aligning the fuel pipe assembly and the fuel housing relative to each other; inserting a portion of one of the fuel pipe assembly and the fuel housing into the other of the fuel pipe assembly and the fuel housing; deflecting at least a portion of the connector while performing the step of inserting; and effecting a snap together engagement of the connector with the one of the fuel pipe assembly and the fuel housing to which the connector was not secured in position relative to as part of the step of providing.

An advantage of the present invention is providing structure for connecting fuel pipe assemblies to motor vehicle fuel system housings that can be snapped together or otherwise connected without the use of tools.

Another advantage of the present invention is providing structure for attaching fuel housings and fuel pipe assemblies of all types, including those having screw caps and those that are capless.

Yet another advantage of the present invention is providing an attachment system for fuel pipe assemblies that installs easily yet has high retention force.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a vehicle refueling system having a connector system in accordance with the present invention between a fuel pipe assembly and a fuel housing of the refueling system;

FIG. 2 is an exploded view of part of the refueling system shown in FIG. 1, revealing a connector of the present invention;

FIG. 3 is an exploded view of the vehicle refueling system and connector shown in FIG. 2, with the connector in position on the fuel pipe assembly and aligned for connection to a fuel housing;

FIG. 4 is an enlarged cross-sectional view of the vehicle refueling system shown in the previous views;

FIG. 5 is a plan view of a further embodiment of a connector in accordance with the present invention;

FIG. 6 is an exploded view of part of a vehicle refueling system, including a fuel pipe assembly and of the connector shown in FIG. 5;

FIG. 7 is an enlarged cross-sectional view of the vehicle refueling system partially shown in FIG. 6;

FIG. 8 is an exploded view of a third embodiment of the present invention, including a fuel pipe assembly and yet another embodiment for a connector;

FIG. 9 is an enlarged partial cross-sectional view of a vehicle refueling system assembly including the embodiment shown in FIG. 8;

FIG. 10 is an exploded view of a fourth embodiment of the present invention, illustrating a vehicle refueling system including a fuel pipe assembly, connector and fuel housing;

FIG. 11 is an enlarged cross-sectional view of an assembled vehicle refueling system in accordance with the embodiment shown in FIG. 10;

FIG. 12 is an end view of the assembled embodiment shown in FIG. 11;

FIG. 13 is a perspective view of a fuel housing in accordance with a fifth embodiment of the present invention; and

FIG. 14 is a plan view of the end of a fuel pipe assembly suitable for use with the fuel housing shown in FIG. 13.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of ‘including’, ‘comprising’ and variations thereof is meant to encompass the items listed thereafter and equivalents thereof, as well as additional items and equivalents thereof.

### DETAILED DESCRIPTION OF THE PREFERRED EMBODIMENT

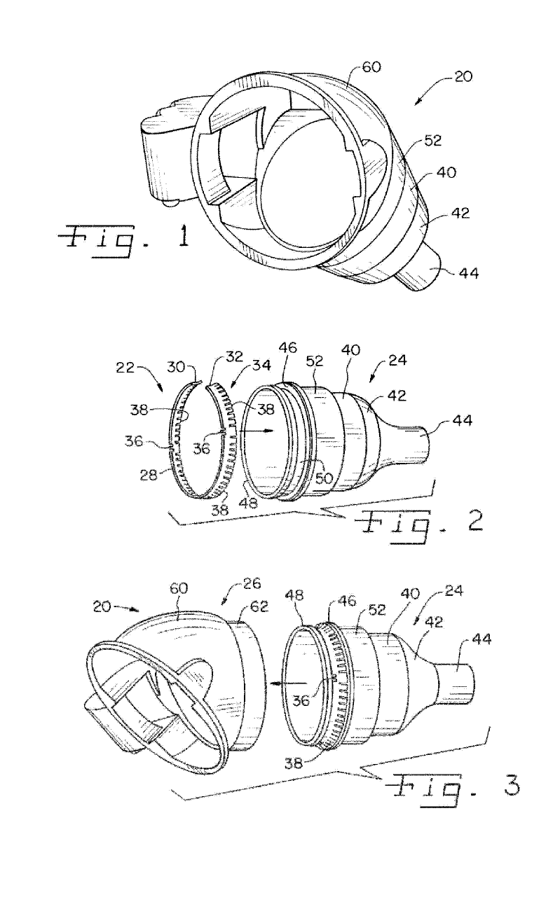

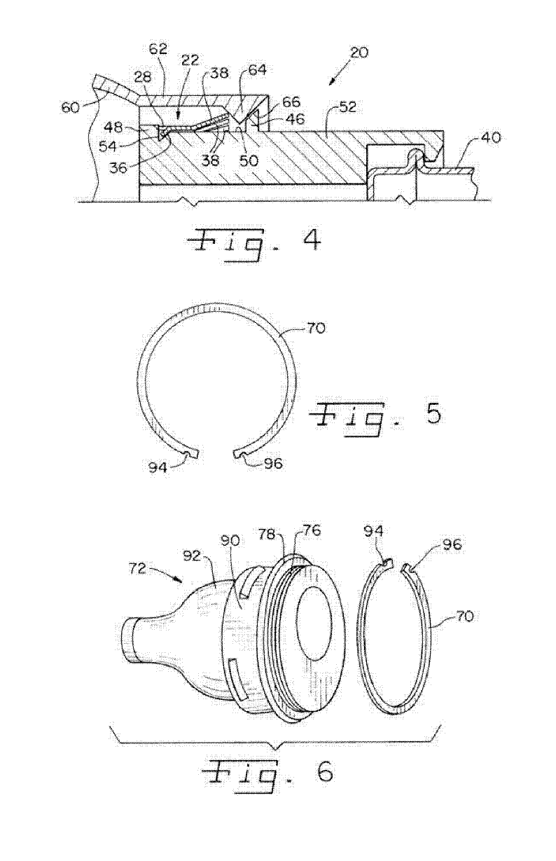

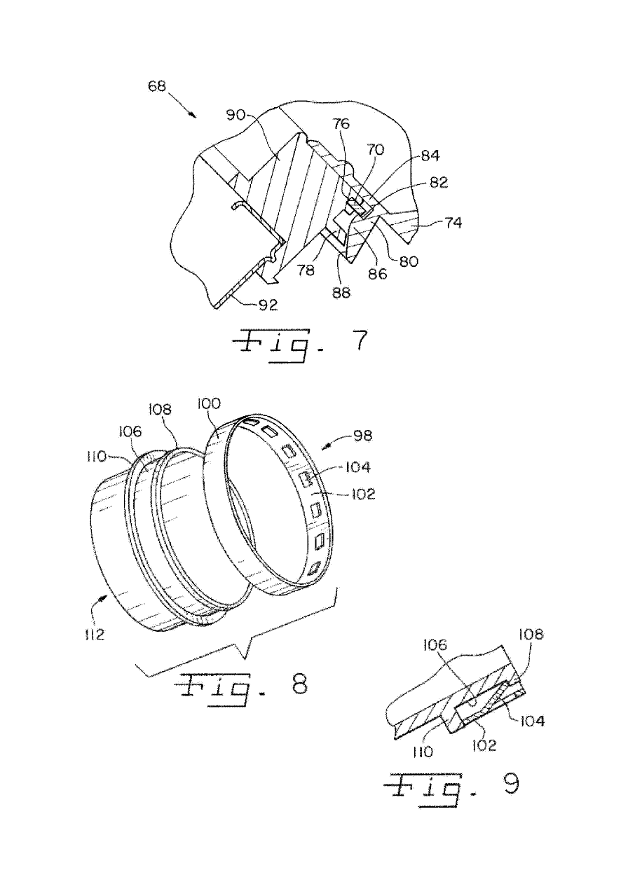

Referring now more specifically to the drawings and to FIG. 1 in particular, a vehicle refueling system 20 is shown. Refueling system 20 includes a connector 22 (FIG. 2) in accordance with the present invention between and connecting a fuel pipe assembly 24 and a fuel housing 26. The present invention can be used for refueling systems of various types, including those with fuel pipe assemblies having screw-on caps, and capless refueling systems and the like. The specific fuel pipe assembly 24 and fuel housing 26 shown in the drawings are merely for illustrative purposes and should not be considered as limiting on the present invention.

Connector 22 is a hoop-like structure having a substantially continuous band 28 with closely adjacent opposed ends 30, 32 and an outwardly angled skirt 34. Band 28 defines one or more inwardly angled tab 36, two tabs 36 being readily visible in FIG. 2. Skirt 34 has a plurality of teeth 38 contiguous with band 28, but otherwise separated from each other. Only some teeth 38 and not all teeth 38 have been designated with a reference numeral in the drawings. Teeth 38 angle outwardly from band 28, to define an outer circumference larger than band 28. Connector 22 can be made of plastic, metal and other suitable materials, and can be made as an elongated stamping from substantially flat sheet material. Thereafter, the stamping can be rolled into the substantially hoop-like configuration shown. The angular outward orientation of teeth 38 can be consistent among all teeth 38, or a wave configuration can be stamped therein to allow for tolerance compensation in the completed assembly. A wave configuration in teeth 38 can be seen in FIG. 4 wherein three teeth 38 are visible at different elevations relative to a base of channel 50.

Fuel pipe assembly 24 includes an upper cup 40, a primary shut-off valve 42 and a fuel pipe 44 leading to and fluidly connected to a fuel tank (not shown). The present invention can be used advantageously with fuel pipe assemblies 24 of various types having various different primary shut-off assemblies 42. Fuel pipe assembly 24 further includes a circumferential flange 46 and outer lip 48 spaced from each other on an outer surface of upper cup 40. Accordingly, a trough or channel 50 is defined between flange 46 and lip 48. Flange 46 and outer lip 48 defining channel 50 there between can be part of a monolithic structure for upper cup 40 or can be provided as part of an adapter 52 (FIG. 4) connected to upper cup 40. Adapters 52 of various types can be provided for connecting to upper cups 40 of different types. By connecting an adapter 52 the present invention can be used with a variety of different shutoff valve assemblies including screw cap and capless systems.

Connector 22 is received in channel 50, between lip 48 and flange 46. A groove 54 (FIG. 4) is provided in channel 50 adjacent lip 48. Tabs 36 on band 28 project inwardly into groove 54, as illustrated in FIG. 4. In a preferred embodiment, groove 54 is substantially continuous around channel 50 so that rotational alignment of connector 22 relative to fuel pipe assembly 24 is not required. Tabs 36 are received in groove 54 for any rotational position of connector 22.

Fuel housing 26 includes an access enclosure 60 and a collar 62 extending from enclosure 60. Collar 62 is of sufficient size to fit over lip 48. Collar 62 defines an abutment such as an annular rib 64 extending inwardly in collar 62. As illustrated in the cross-sectional view of the assembly shown in FIG. 4, rib 64 is substantially triangular in cross-section, and is received between teeth 38 and flange 46 in the completed assembly.

The embodiment of the present invention just described is assembled by sliding connector 22 onto fuel pipe assembly 24. Specifically, skirt 30 slides over lip 48, with the hoop-like structure expanding as necessary by separating between ends 30, 32 so that band 28 slides over lip 48. Band 28 rebounds inwardly and settles into channel 50, with tabs 38 resting in groove 54. Thereafter, fuel housing 26 is connected by relative axial movement of collar 62 and upper cup 40, such that rib 64 is moved past lip 48 and channel 50. Teeth 38 are deflected inwardly as rib 64 slides past and abuts flange 46. As illustrated in the preferred embodiment of FIG. 4, rib 64 is generally triangular in cross-section and flange 46 has an angled upper face 66 such that rib 64 and flange 46 engage flat, one against the other. The abutment of confronting surfaces on rib 64 and flange 46 limit the relative movement between fuel pipe assembly 24 and fuel housing 26. Teeth 38 engage rib 64 on an opposite side from flange 46 as the teeth spring outwardly when the apex of rib 64 has passed.

Accordingly, connector 22 is held securely between fuel pipe assembly 24 and fuel housing 26 and connects fuel pipe assembly 24 to fuel housing 26 easily. The snap together connections between connector 22 and fuel pipe assembly 24 and between connector 22 and fuel housing 26 can be made with only minimal force required, and without tools. However, fuel pipe assembly 24 and fuel housing 26 cannot be detached easily one from the other because of the interdigitating structures between the components and the angular seating of tabs 38 in groove 54 and outwardly angled teeth 38 against rib 64.

FIGS. 5, 6 and 7 illustrate another embodiment of the present invention in which a vehicle refueling system 68 (FIG. 7) includes a connector 70 between a fuel pipe assembly 72 and fuel housing 74. Connector 70 is in the nature of a snap ring 70, which may be made of metal or plastic. Fuel pipe assembly 72 defines an annular channel 76 in which connector 70 is received. Fuel pipe assembly 72 further defines a circumferential flange 78 spaced from channel 76. Fuel housing 74 includes a collar 80 having an abutment 82 in spaced relation to a wall 84 of housing 74. Abutment 82 is a substantially flat face of an annular enlargement 86 in collar 80. Enlargement 86 has a sloped face 88 between a diametrically wider outer portion and a diametrically more narrow inner portion. Connector 70 is of greater diametrical width than the depth of channel 76. Accordingly, as shown in FIG. 7, a portion of connector 70 projects radially outwardly from channel 76 and is engaged against abutment 82 in the completed assembly. A distal end of flange 78 confronts and abuts enlargement 86 along sloped face 88.

During assembly of the embodiment shown in FIGS. 5, 6 and 7, connector 70 is expanded and snapped into annular channel 76 on fuel pipe assembly 72, and fuel pipe assembly 72 with connector 70 positioned therein is inserted into fuel housing 74. As enlargement 86 slides past connector 70, collar 80 deflects outwardly and connector 70 compresses into channel 76. Each rebounds to a natural position illustrated in the cross-section of FIG. 7, which positions are self-engaging one to another. Flange 78 on fuel pipe assembly 72 provides a physical stop that limits the distance fuel pipe assembly 72 can be pushed into fuel housing 74 upon abutting enlargement 86. As with the first described embodiment of refueling system 20, vehicle refueling system 68 can be snapped together with minimal force and without tools. However, after assembly, the components of refueling system 68 can not be dislodged easily.

To facilitate assembly and use with fuel pipe assemblies 72 of different types channel 76 and flange 78 can be defined in and adapter 90 engaging an end of an upper cup 92 of fuel pipe assembly 72. To facilitate disassembly when required, connector 70 is provided with indentations 94, 96 for receiving a tool to expand and remove connector 70.

Still other types of connectors can be used. For example, a connector 100 (FIG. 8) includes a hoop-like band 102 with resilient inwardly extending fingers 104. Fingers 104 are received in a channel 106 between an outer lip 108 and a flange 110 of a fuel pipe assembly 112. Connector 100 is press-fit or molded into a collar of a fuel housing having a space for receiving connector 100, such as the space between abutment 82 and wall 84 in fuel housing 74. With connector 100 thus positioned relative to the fuel housing, fuel pipe assembly 112 is inserted therein. Fingers 104 deflect as necessary while sliding past lip 108. Fingers 104 rebound outwardly securing connector 100 relative to fuel pipe assembly 112. As with the previously described embodiments, assembly is snap-together, requiring minimal force and no tools. However, after assembly is complete, resistance against disconnect is strong, providing a secure assembly.

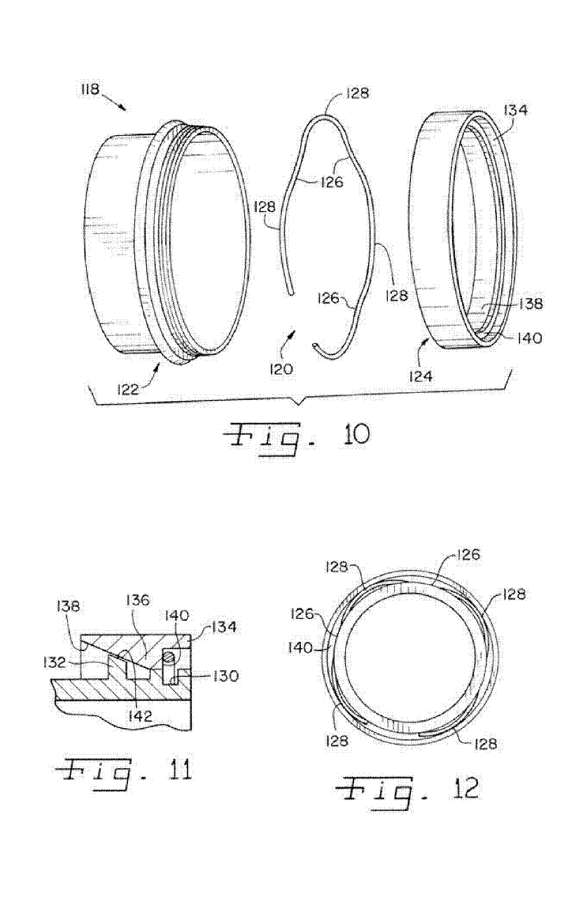

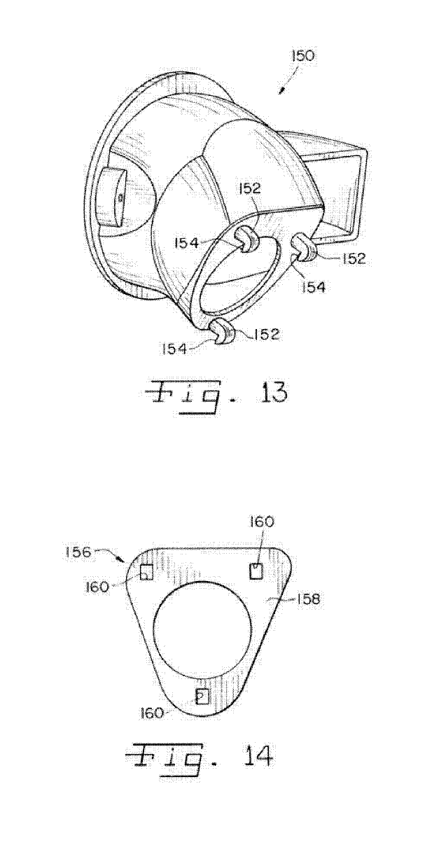

FIGS. 10-12 illustrate yet another embodiment in which a refueling system 118 includes a connector 120 between a fuel pipe assembly 122 and a fuel housing 124. Connector 120 is in the nature of a generally annular shaped wave spring having radially inner portions 126 and radially outer portions 128. Fuel pipe assembly 122 defines a channel 130 near an outer edge of assembly 122, and a circumferential flange 132 inwardly of channel 130. Radially inner portions 126 of connector 120 are received in channel 130, with radially outer portions 128 projecting outwardly from channel 130. Housing 124 includes a collar 134 having an abutment in the way of an annularly inwardly extending rib 136 including a sloped face 138 and an abutment face 140.

During assembly of the embodiment shown in FIGS. 10-12, connector 120 is expanded as necessary, slid over the end of fuel pipe assembly 122 and snapped into annular channel 130. Fuel pipe assembly 122 with connector 120 positioned therein is inserted into fuel housing 124. Sloped face 138 confronts and slides past radially outer portions 128 of connector 120, flattening and compressing radially outer portions 128 into channel 130 and/or deflecting collar 134 as required until abutment face 140 has passed radially outer portions 128. Radially outer portions 128 rebound outwardly and provide an obstruction against the disconnection of fuel pipe assembly 122 from fuel housing 124. Accordingly, radially inner portions 126 are received in channel 130 and radially outward portions 128 are engaged against abutment face 140, thereby securing fuel pipe assembly 122 to fuel housing 124. Flange 132 confronts face 138 to limit axial movement of fuel pipe assembly 122 relative to fuel housing 124. A sloped distal end 142 can be provided on flange 132 to confront sloped face 138 in a flush manner. As with the previously described embodiments, assembly is snap-together, requiring minimal force and no tools. However, after assembly is complete, resistance against disconnect is strong, providing a secure assembly.

Still other connector structures can be used to secure a fuel pipe assembly to a fuel housing in a snap together assembly. FIG. 13 illustrates a fuel housing 150 having connectors in the way of legs 152 molded therein. Distal ends of legs 152 define hooks 154. FIG. 14 illustrates a fuel pipe assembly 156 for connection to fuel housing 150. Fuel pipe assembly 156 includes a barrier plate 158 defining receiving holes 160 into which distal ends of legs 152 are inserted until hooks 154 are on an opposite side of barrier plate 156 from the side shown in FIG. 14. Barrier plate 158 thereby acts as an abutment confronting hooks 154 and inhibiting disconnection of fuel housing 150 and fuel pipe assembly 156 in the completed assembly. Distal end faces of legs 152 at hooks 154 are sloped to facilitate insertion into the receiving holes 160. The sloped surfaces engage barrier plate 158 at regions adjacent receiving holes 160, causing deflection of legs 152 for insertion into receiving holes 160. Legs 152 rebound to non-deflected positions after hooks 154 pass through receiving holes 160. Accordingly, the assembly is snap together, without the need for tools, and retention force is strong, thereby resisting disconnect.

The present invention provides snap-together structures of various types whereby a fuel pipe assembly of any configuration can be connected to a vehicle housing of any design. Assembly is quick and easy, without the need for tools. However, once connected, the connection is secure, and unintended disconnect is restrained.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A vehicle refueling system comprising:
a housing having a collar defining an abutment;
a fuel pipe assembly having an end defining a channel, said end being received in said collar; and
a connector disposed in said channel of said fuel pipe assembly and engaging said abutment in said collar.

2. The vehicle refueling system of claim 1, said connector being substantially hoop-like and having a band disposed in said channel and an outwardly angled skirt engaging said abutment.

3. The vehicle refueling system of claim 2, said channel defining a groove at a base thereof, and said band having inwardly angled tabs disposed in said groove.

4. The vehicle refueling system of claim 2, said skirt comprising teeth.

5. The vehicle refueling system of claim 4, said fuel pipe assembly defining a circumferential flange and said abutment being a rib constrained between said flange and said skirt.

6. The vehicle refueling system of claim 5, said rib being of a size and configuration for sliding past said band and for deflecting said teeth inwardly to slide to there past.

7. The vehicle refueling system of claim 1, said connector having at least portions thereof that are inwardly deflectable for assembly.

8. The vehicle refueling system of claim 7, said connector being substantially annular.

9. The vehicle refueling system of claim 7, said connector being a wave spring in a generally annular shape and having a radially inner portions disposed in said channel and radially outer portions engaging said abutment.

10. The vehicle refueling system of claim 7, said the connector being a band having a plurality of inwardly projecting fingers.

11. The vehicle refueling system of claim 7, said connector being a snap ring.

12. The vehicle refueling system of claim 1, said fuel pipe assembly defining a flange engaging a portion of said fuel housing and limiting axial insertion of said fuel pipe assembly relative to said fuel housing.

13. The vehicle refueling system of claim 1, said connector being a separate piece connectable to and removable from said fuel pipe assembly and said fuel housing.

14. A connector assembly for a vehicle refueling system having a fuel pipe assembly and a fuel housing, said connector assembly comprising:
a connector held by one of said fuel pipe assembly and said fuel housing in a substantially fixed position, and a portion of said connector extending toward the other of said fuel pipe assembly and said fuel housing;
said other of said fuel pipe assembly and said housing defining an abutment; and
said portion of said connector configured and positioned engaged against said abutment.

15. The connector assembly of claim 14, said fuel pipe assembly defining a channel, said connector comprising a band disposed in said channel; said portion of said connector projecting outwardly from said band; and said abutment comprising a substantially annular rib defined in said fuel housing.

16. The connector assembly of claim 14, said connector comprising a wave spring in generally annular shape, said wave spring having radially inner portions and radially outer portions; said fuel pipe assembly defining a channel; said radially inner portions of said wave spring being disposed in said channel; and said radially outer portions of said wave spring projecting outwardly from said channel and engaging said abutment, said abutment being a substantially annular rib defined in said fuel housing.

17. The connector assembly of claim 14, said connector being a snap ring.

18. The connector assembly of claim 14, said connector being a hoop-like structure having radially inwardly projecting fingers.

19. The connector assembly of claim 14, said fuel housing defining legs having hooks on distal ends thereof, and said fuel pipe assembly including a barrier plate defining receiving holes through which said legs extend, with said hooks engaging a surface of said barrier panel opposite said fuel housing.

20. A method for connecting a vehicle fuel pipe assembly to a fuel housing comprising steps of:
providing at least one connector secured in position relative to one of the fuel pipe assembly and the fuel housing;
aligning the fuel pipe assembly and the fuel housing relative to each other;
inserting a portion of one of the fuel pipe assembly and the fuel housing into the other of the fuel pipe assembly and the fuel housing;
deflecting at least a portion of the connector while performing said step of inserting; and
effecting a snap together engagement of the connector with the one of the fuel pipe assembly and the fuel housing to which the connector was not secured in position relative to during said step of providing at least one connector secured in position relative to one of the fuel pipe assembly and the fuel housing.

21. The method of claim 20, including expanding the connector and placing the expanded connector in a channel defined in one of the fuel pipe assembly and the fuel housing for securing the connector in position relative thereto.

22. The method of claim 20, including providing the connector as a plurality of legs integral with one of the fuel pipe assembly and the fuel housing, and inserting the legs into receiving holes in the other of the fuel pipe assembly and fuel housing.

23. The method of claim 20, including sliding the connector onto one of the fuel pipe assembly and the fuel housing and moving the fuel pipe assembly and fuel housing relative to each other after the sliding step and thereby engaging the other of the fuel pipe assembly and fuel housing with the connector.
